(19) United States
(12) Patent Application Publication
(10) Pub. No.: US 2008/0250886 A1
(43) Pub. Date: Oct. 16, 2008

(54) Automatic clearance compensator of support yoke for use in rack and pinion type steering apparatus

(76) Inventor: Joon-kyu Song, Seongnam (KR)

Correspondence Address: HARNESS, DICKEY & PIERCE, P.L.C., P.O. BOX 828, BLOOMFIELD HILLS, MI, 48303, US

(21) Appl. No.: 12/080,785

(22) Filed: Apr. 4, 2008

(30) Foreign Application Priority Data
Apr. 10, 2007 (KR) 10-2007-0035227

(51) Int. Cl. F16H 1/04

(52) U.S. Cl. 74/422

(57) ABSTRACT

Disclosed is an automatic clearance compensator of a support yoke in a rack and pinion type steering apparatus, which includes: a support yoke supporting a rack bar; a spring disposed at a rear surface of the support yoke so as to exert force in a direction of the rack bar; a yoke plug supporting the spring; cams supporting the support yoke and the spring; and a cam fixing member disposed between the support yoke and the yoke plug, the cam fixing member having grooves for receiving the cam being formed on the cam fixing member. According to the present invention, clearance generated between a rack bar and the support yoke can be automatically compensated, and noise generating between the support yoke and the yoke plug can be also prevented even if impact is inversely exerted on the rack bar.

### CROSS-REFERENCE TO RELATED APPLICATION

This non-provisional application claims priority under 35 U.S.C § 119(a) on Patent Application No. 10-2007-0035227 filed in Korea on Apr. 10, 2007, the entire contents of which are hereby incorporated by reference.

### BACKGROUND OF THE INVENTION

1. Field of the Invention

The present invention relates to an automatic clearance compensator of a support yoke in a rack and pinion type steering apparatus, and more particularly to an automatic clearance compensator of a support yoke in a rack and pinion type steering apparatus, which automatically compensating clearance, generated in the support yoke included in the rack and pinion type steering apparatus, by means of a spring and a cam mechanism without a separate adjusting operation.

2. Description of the Prior Art

A steering apparatus is an apparatus allowing a driver to change a direction that a vehicle progresses in according to the driver's desire, and is an apparatus voluntarily changing a rotational center, about which a front wheel rotates, so as to allow the vehicle to progress in the desired direction.

FIG. 1 is a schematic view illustrating a structure of a typical steering apparatus for a vehicle and FIG. 2 is a side sectional view illustrating a conventional rack and pinion type gear box.

As shown in FIG. 1, the conventional steering apparatus includes a steering wheel 100, a steering shaft 105 connected with the steering wheel 100, a steering column 103 allowing the steering shaft 105 to be fixed in a chassis, a gear box 130 including a rack gear 110 and a pinion gear 120 for converting rotational force inputted from the steering shaft 105 into the linear movement, a rack bar 140 including an inner ball joint 135, a tie rod 150 integrally formed with a ball of the inner ball joint 135, and an outer ball joint 155 disposed at an end of the tie rod 150. Also, the tie rod 150 is connected with a knuckle 159 of a tire 158 via the outer ball joint 155. The reference numeral ‘170’ indicates a cylinder for housing the rack bar.

The conventional rack and pinion type gear box 130 includes a pinion shaft 276, a rack bar 140, a support yoke 260, spring 263, a yoke plug 265 and a rack housing 270. The rack and pinion type gear box 130 converts rotational force inputted from the steering shaft 105 to the linear and reciprocal movement as described above.

The pinion shaft 276 receives rotational force from an input shaft 275 connected with the steering shaft 105, and transfers the rotational force to the rack bar 140. The pinion shaft 276 is connected with the input shaft 275 through the torsion bar 273, and a pinion gear 120 engaged with the rack gear 110 is formed at an end of the pinion shaft 276.

The rack bar 140 is engaged with the pinion shaft 276 so as to convert rotational force to linear movement. The rack bar 140 is in a shape of a bar extending between front wheels of a vehicle, and includes inner ball joints 135 formed at both end of the rack bar 140. The rack gear 110, with which the pinion shaft 276 is engaged, is formed between the inner ball joints 135 of both sides of the rack bar 140.

The support yoke 260 reduces clearance between the rack bar 140 and the pinion shaft 276 so as to achieve smooth transference of power. The support yoke 260 is positioned at a rear surface of the rack bar 140, which is a surface opposite to a surface at which the rack gear 110 is formed. The support yoke 260 is inserted into the rack housing 270 having a cylinder 170 formed therein, and can move in front and rear directions.

The support yoke 260 has a cylindrical shape so as to slide within the rack housing 270 in front and rear directions, and the front part of the support yoke 260 in contact with the rack bar 140 has a groove of a semi-circular shape so as to make close contact with a rear surface of the rack bar 140.

Also, in order to allow the rack bar 140 and the pinion shaft 276 to make close contact with each other so as to effectively transfer power, the spring 263 is arranged at a rear side of the support yoke 260 so as to push the support yoke 260 under a predetermined amount of pressure, thereby compensating clearance generated between the rack bar 140 and the pinion shaft 276.

As such, the support yoke 260 makes sliding friction against a rear surface of the rack bar 140. Therefore, in order to prevent abrasion of the rack bar 140 and generation of noise, a support yoke 260 made from plastic having softness, rather than material of the rack bar 140, is used.

The spring 263 performs a function for exerting pressure so as to allow the support yoke 260 and the rack bar 140 to make close contact with each other, and a coil spring is typically used as the spring. A yoke plug 265 is disposed at a rear surface of the spring 263 so as to support the spring 263.

The yoke plug 265 supports the spring 263 so as to allow the spring 263 to exert pressure on the support yoke 260. The yoke plug 265 has typical male-screw type threads so that the yoke plug 265 can be assembled with the rack housing 270 having typical female-screw type threads. The yoke plug 265 has a groove formed at a rear surface thereof so as to allow a wrench to be inserted into the groove. Therefore, when the yoke plug 265 is assembled, or clearance between the rack bar 140 and the pinion shaft 276 is generated, tension of the spring 263 can be adjusted in such a manner that the yoke plug 265 is tightened by the wrench.

That is, the support yoke 260, the spring 263 and the yoke plug 265 are elements for supporting the rack bar 140. In a conventional structure where clearance between the rack bar 140 and the pinion shaft 276 is compensated in such a manner that the spring 263 exerts pressure to the support yoke 260, a gap A of about 0.05 mm is formed between the yoke plug 265 and the support yoke 260. However, the support yoke 260 is moved forward in a direction of the rack bar 140 because of long term use so that the gap A between the yoke plug 265 and the support yoke 260 increases. In this case, when the size of the gap A increases to be more than about 0.15 mm, noise generates due to vibration. In the other hand, even if the size of the gap A does not increase, the rack bar 140 is elastically deformed in an instant by impact inputted in an inverse direction from the tire 158 to the rack bar 140 while vehicle is driven on an irregular road surface, etc., so that impact is exerted to the support yoke 260 in a direction of the yoke plug 265. Therefore, noise is generated.

### SUMMARY OF THE INVENTION

Accordingly, the present invention has been made to solve the above-mentioned problems occurring in the prior art, and the present invention provides an automatic clearance compensator of a support yoke in a rack and pinion type steering apparatus, which automatically compensates clearance, generated due to abrasion of the support yoke included in the rack and pinion type steering apparatus, by means of a plurality of cams and a cam fixing member without a separate adjusting operation.

Also, the present invention provides an automatic clearance compensator of a support yoke in a rack and pinion type steering apparatus, which includes: a support yoke supporting a rack bar; a spring disposed at a rear surface of the support yoke, which is a surface opposite to a surface facing the rack bar, so as to push the support yoke in a direction of the rack bar; a yoke plug supporting the spring; cams positioned between the support yoke and the yoke plug so as to support the support yoke and the spring; and a cam fixing member disposed between the support yoke and the yoke plug, the cam fixing member having grooves for receiving the cam.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view illustrating a structure of a typical steering apparatus for a vehicle;

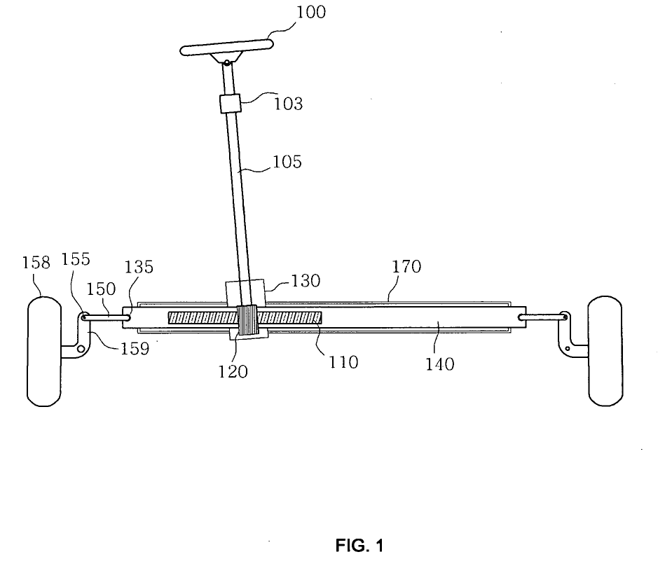

FIG. 2 is a side sectional view of a conventional rack and pinion type gear box;

FIG. 3 is an exploded perspective view of an automatic clearance compensator of a support yoke according to an exemplary embodiment of the present invention; and

FIG. 4 is a sectional view illustrating an operational state of cams according to an exemplary embodiment of the present invention.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components, and so repetition of the description on the same or similar components will be omitted.

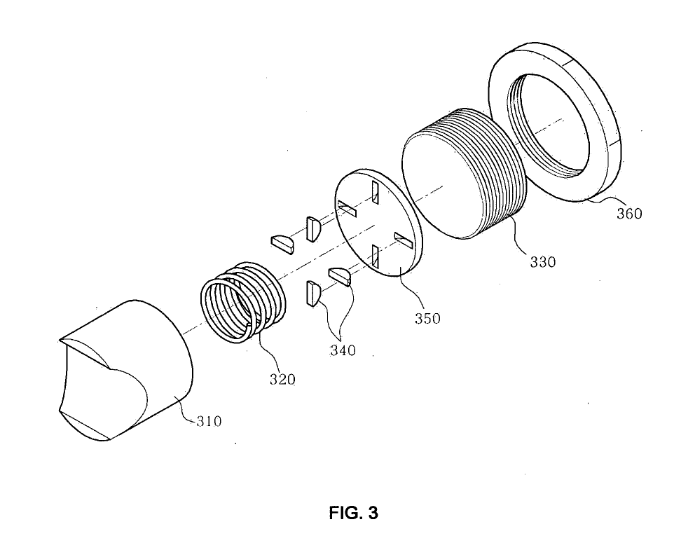

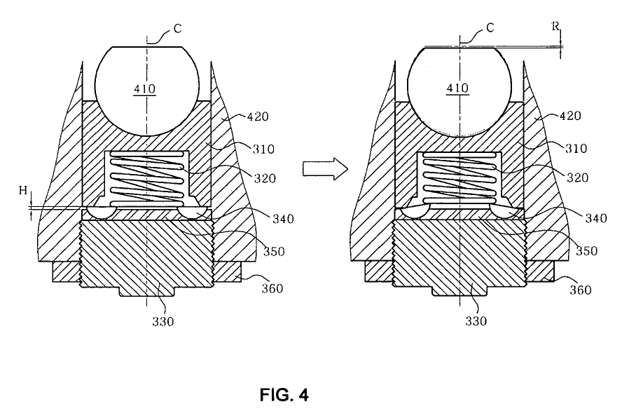

FIG. 3 is an exploded perspective view of an automatic clearance compensator of a support yoke according to an exemplary embodiment of the present invention and FIG. 4 is a sectional view illustrating an operational state of cams according to an exemplary embodiment of the present invention. The automatic clearance compensator of a support yoke according to an exemplary embodiment of the present invention is a structure supporting a rack bar 410 which is inserted into a rack housing 420 and reciprocally moves in right and left directions, and includes a support yoke 310, a spring 320, a yoke plug 330, cams 340, and a cam fixing member 350.

The support yoke 310 has a cylindrical shape so as to slide within the rack housing 420 in front and rear directions, and the front part of the support yoke 310 in contact with the rack bar 410 has a groove of a semi-circular shape so as to make close contact with a rear surface of the rack bar 410.

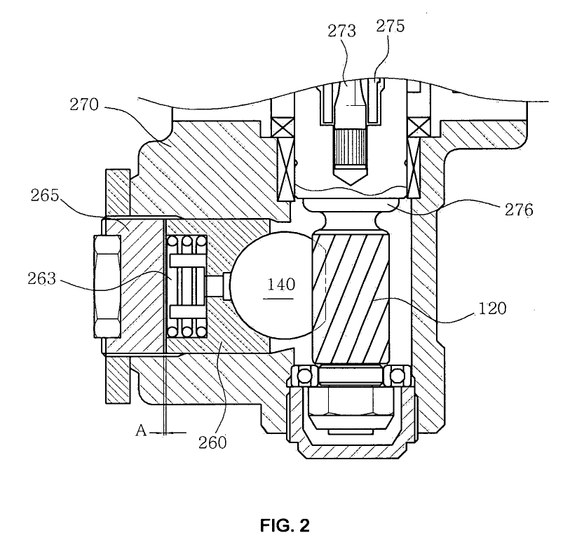

A cylindrical shaped space having a predetermined depth is formed at the rear part of the support yoke 310. The spring 320 inserted into this space pushes the support yoke 310 under a predetermined amount of pressure, thereby compensating clearance generated between the rack bar 140 and the pinion shaft 276 (see FIG. 2), and the spring 320 simultaneously exerts pressure to the support yoke 310 so that the support yoke 310 and the rack bar 410 make close contact with each other. A coil spring is typically used as the spring 320.

The cams 340 and a cam fixing member 350 are included at a rear surface of the support yoke 310 and at a rear part of the spring 320. Each cam 340 has a sectional shape of a rough semi-circle. A front surface of the cam 340, which is in contact with the support yoke 310 and the spring 320, is a flat shape, and a rear surface of the cam 340 is a curved surface having a predetermined curvature.

As shown in FIG. 4, an inner portion of the front surface of the cam 320, which is positioned near to a central shaft C of the support yoke 310 and the yoke plug 330, is in contact with the spring 320, and an outer portion thereof is in contact with the support yoke 310.

The positions of the cams 320 are accurately described below. The cams 320 are positioned between the support yoke 310 and the yoke plug 330, and are radially arranged while centering the central shaft C. The number of the cams 340 is not limited if it is more than two, but it is preferable that the number of the cams is three through five.

The cam 340 is a component which receives impact transferred from the rack bar 410 and elastic force from the spring 320 and supports the support yoke 310. Therefore, the cam 340 is preferably made from plastic or metal having a strong property.

Meanwhile, grooves having a curvature equal to the curvature of each rear surface of the cams 320 are formed at a front surface of the cam fixing member 350 according to the number of the cams 340. Therefore, when the automatic clearance compensator of a support yoke according to the present invention is assembled with the rack housing 420, the grooves perform a function for limiting the position of each cam 340.

The cam fixing member 350 is a member where friction against the cam 340 is frequently generated. Therefore, it is preferable that the cam fixing member 350 is made from material allowing friction against the cam 340 to be minimized, and hydraulic fluid, such as oil, etc, is spread on a surface where the cam 340 and the cam fixing member 30 make contact with each other.

The yoke plug 330 is positioned at a rear surface of the cam fixing member 350 and is screw-assembled with the rack housing 420. Threads are formed at a portion of an inner circumferential surface of the rack housing 420 and an outer circumferential surface of the yoke plug 330, respectively. The yoke plug 330 is a member supporting the support yoke 310, the spring 320, the cams 340 and the cam fixing member 350. The yoke plug 330 is screw-assembled with the rack housing 420 and then the lock nut 360 is fastened to a portion of the yoke plug 330, which extends from the rack housing 420.

The lock nut 360 also has threads formed at an inner circumferential surface thereof, and is assembled with the yoke plug 330 so that the lock nut 360 fixes the yoke plug 330. Therefore, the lock nut 360 prevents the yoke plug 330 from releasing from the rack housing 420 due to vibration, etc.

In the automatic clearance compensator of a support yoke according to the present invention, the support yoke 310, the spring 320, the cams 340, the cam fixing member 350 and the yoke plug 330 are positioned at a rear side of the rack bar 410, and they are sequentially inserted into the rack housing 420.

The operational method of the automatic clearance compensator of a support yoke rack bar will be described below. When impact is inversely inputted through the rack bar 410, the support yoke 310 moves toward the yoke plug 330 so that the cams 340 in contact with the support yoke 310 slip and rotate along the groove formed on the cam fixing member 350, and the support yoke 310 moves so that the compressed spring 320 is further compressed by the rotating cams 340.

Accordingly, since the distance where the spring 320 is compressed, is nearly two times in comparison with the distance where the support yoke 310 moves, the automatic clearance compensator of a support yoke has supporting force stronger than that of a conventional rack bar supporting structure.

Herein, when the rack bar 410 is elastically deformed so that a distance H between the support yoke 310 and the cam fixing member 350 is larger than the maximized distance R where the support yoke 310 can move toward the yoke plug 330, the support yoke 310 and the cam fixing member 350 do not make contact with each other. Therefore, noises do not generate between the support yoke 310 and the cam fixing member 350

Also, in addition to the conventional supporting structure including only a support yoke 310, a spring 320 and a yoke plug 330, the cams 340 and the cam fixing member 350 are additionally included between the support yoke 310, the spring 320 and the yoke plug 330. Therefore, even if the front surface of the support yoke 310 is worn away due to a reciprocal movement of the rack bar 410 in left and right directions, it goes without saying that clearance is automatically compensated by the spring 320, the cams 340 and the cam fixing member 350.

According to the present invention as described above, clearance generated between the support yoke and the rack bar is automatically compensated, and even if impact is inversely inputted into the rack bar, it is also possible to prevent noise generated between the support yoke and the yoke plug.

Although an exemplary embodiment of the present invention has been described for illustrative purposes, those skilled in the art will appreciate that various modifications, additions and substitutions are possible, without departing from the scope and spirit of the invention as disclosed in the accompanying claims. Therefore, the embodiment disclosed in the present invention has been described not for limiting the spirit of the present invention, but for illustrative purposed, and the scope of the present invention may not be limited to the embodiment. Accordingly, the scope of the invention is not to be limited by the above embodiments but by the claims and the equivalents thereof.

What is claimed is:

1. An automatic clearance compensator of a support yoke in a rack and pinion type steering apparatus, comprising:
a support yoke supporting a rack bar;
a spring disposed at a rear surface of the support yoke, which is a surface opposite to a surface facing the rack bar, so as to push the support yoke in a direction of the rack bar;
a yoke plug supporting the spring;
cams positioned between the support yoke and the yoke plug so as to support the support yoke and the spring; and
a cam fixing member disposed between the support yoke and the yoke plug, the cam fixing member having grooves for receiving the cam.

2. The automatic clearance compensator of a support yoke as claimed in claim 1, wherein a plurality of cams is radially arranged while centering a central shaft of the support yoke and the yoke plug.

3. The automatic clearance compensator of a support yoke as claimed in claim 1, wherein each rear surface of the cams is a curved surface having a predetermined curvature.

4. The automatic clearance compensator of a support yoke as claimed in claim 3, wherein grooves, which have a curvature equal to the curvature of the rear surface of each cam, are radially formed at a front surface of the cam fixing member.
